(19) United States
(12) Patent Application Publication
(10) Pub. No.: US 2009/0230101 A1
(43) Pub. Date: Sep. 17, 2009

(54) METHOD OF SOLDERING METALLIC JOIN PARTNERS AND AN APPRATUS FOR THIS PURPOSE

(76) Inventors: Dirk HANSCH, Hauset (BE); Marc Deschler, Aachen (DE)

Correspondence Address: BERENATO, WHITE & STAVISH, LLC, 6550 ROCK SPRING DRIVE, SUITE 240, BETHESDA, MD, 20817, US

(21) Appl. No.: 12/401,163

(22) Filed: Mar. 10, 2009

(30) Foreign Application Priority Data
Mar. 11, 2008 (EP) 08004447.2

(51) Int. Cl. B23K 26/20; B23K 37/04; B23K 1/00

(52) U.S. Cl. 219/121.64; 228/176; 228/44.3; 219/121.63

(57) ABSTRACT

A method of soldering metallic join partners (4, 5) which are coated with soldering material, wherein the layers of soldering material of the join partners (4, 5) are pressed together and melted in a soldering region (6), molten masses of liquid soldering material forming which, after being mixed, in the solidified state connect the join partners (4, 5) in the soldering region (6), before solidification a mechanical pulse being transmitted to the molten masses of liquid soldering material.

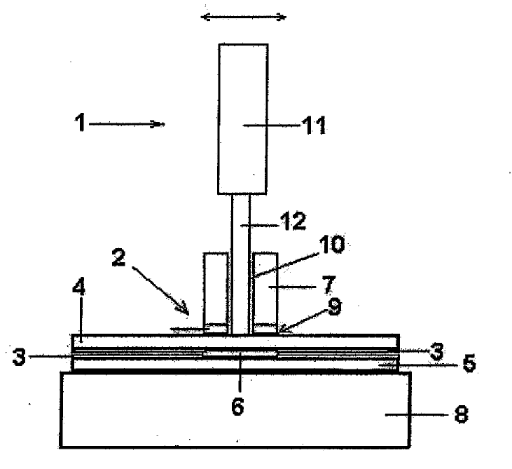

The invention relates to a method of soldering metallic join partners which are coated with soldering material, wherein the layers of soldering material of the join partners are pressed together and melted in a soldering region, molten masses of liquid soldering material forming which, after being mixed, in the solidified state connect the join partners in the soldering region. A further aspect of the invention relates to an apparatus for implementing the method.

In the prior art methods are known for the soldering of metallic join partners which are coated with soldering material. Join partners can be, for example, metal sheets which are provided with a coating of a soldering material. With the known methods, the coatings of soldering material of the latter are brought into contact and pressed together. Then the soldering material is melted onto the join partners, the energy required being supplied, for example, with the aid of a laser beam. A molten mass of liquid soldering material forms here on both metal sheets which combine to form one molten mass. After cooling down, the solidified combined molten mass forms a solder joint which connects the join partners in the soldering region.

With the known method it is necessary to use flux materials in order to guarantee homogeneous mixing of the molten masses of liquid soldering material and e.g. good wetting of the metal sheet surfaces. However, even when using flux materials one does not always succeed in guaranteeing sufficient wetting of the metal sheets to be soldered, and so the solder connections produced do not have a sufficient mechanical load capacity.

It is therefore the object of the present invention to specify a method of the type specified at the start wherein solder connections with a particularly high mechanical load capacity can be produced without the addition of flux materials.

This object is achieved according to the invention in that a mechanical pulse is transmitted to the molten masses of liquid soldering material before solidification.

The basic idea behind the invention is to melt the soldering material on the join partners without adding any flux materials, and then to transmit a mechanical pulse to the molten masses of liquid soldering material. In this way the combination of the molten masses to form a homogeneous molten mass is supported. As a consequence of the pulse transmission intensive mixing of the molten masses thus takes place, at the same time any oxide layers and impurities present on the surface of the individual molten masses, which may prevent combination of the molten masses, being destroyed. Moreover, the contribution of the transmission of the mechanical pulse is that the surfaces of the join partners to be connected are particularly well wetted with the liquid soldering material, and so overall, after solidification of the molten mass, a solder connection with a high mechanical load capacity is obtained.

According to a first embodiment of the invention provision is made to move the join partners impulsively in the soldering region in order to transmit the pulse onto the molten masses of soldering material. In particular, it is possible here to move the join partners in relation to one another in the soldering region.

Advantageously, the join partners are moved in relation to one another here for a period of a few ms. For example, the join partners can be moved in relation to one another for less than 50 ms, and in particular for less than 10 ms.

According to a further embodiment of the invention the layers of soldering material can be melted with a laser beam. It is possible here, for example, with metal sheets to be soldered, to direct the laser beam onto a metal sheet which then transmits the heat onto the layers of soldering material directly or indirectly in contact with the sheet metal so that the latter melt in the soldering region.

It is also possible to transmit a mechanical pulse onto the molten masses of liquid soldering material using a pressing element.

A number of short pulses can also be transmitted to the molten masses of liquid soldering material. In particular here, pulses with a small amplitude can be transmitted. A further aspect of the invention relates to an apparatus for implementing the method with the features of claim 1. Advantageous further developments of the apparatus according to the invention are specified in the sub-claims.

In the following, the invention is described in greater detail by means of an exemplary embodiment with reference to the drawing. In the drawing the single FIGURE shows a diagrammatic illustration of an apparatus for soldering metallic join partners which are respectively coated with soldering material.

The apparatus 1 has a pressing device 2 in order to press two metal sheets 4, 5 respectively provided with a layer of soldering material 3 against one another in a soldering region 6.

The pressing device 2 comprises a pressing element 7 and a support element 8 which between them form a pressing gap 9. In the pressing gap 9 the metal sheets 4, 5 are disposed one over the other such that their respective layers of soldering material 3 come into contact with one another.

The pressing element 7 is connected to the pressure application means (not shown in the drawing) which are designed to apply pressure to the pressing element 7 in the direction of the pressing gap 9. Furthermore, a coaxially extending passage opening 10 is formed in the pressing element 7. Connected in addition to the pressing element 7 are pulse transmission means (likewise not shown in the drawing) which make it possible to move the pressing element 7 impulsively in a horizontal direction.

Furthermore, the apparatus 1 has a laser 11 as a heating device which is positioned such that it can emit a laser beam 12 through the passage opening 10 of the pressing element 7 onto the metal sheet 4. Here the laser 11 is also connected to the pulse transmission means.

In order to solder the metal sheets 4, 5 with the apparatus 1 said metal sheets are pressed together in the pressing gap with the aid of the pressing element 7. At the same time a laser beam 12 is emitted onto the metal sheet 4 by the laser 11 by means of which said metal sheet heats up so that the layer of soldering material 3 applied onto the metal sheet melts in the soldering region 6. Due to the thermal contact between the metal sheet 4 and the layer of soldering material 3 of the latter and the layer of soldering material 3 of the metal sheet 5, heat is also transmitted to this layer of soldering material 3 so that it is also melted in the soldering region 6.

In order to support the connection of the two molten masses which have formed and at the same time to achieve the most complete wetting possible of the two metal sheets 4, 5 in the soldering region 6 a mechanical pulse is then transmitted to the molten masses. For this purpose the pressing element 7 is moved horizontally to and fro impulsively with the aid of the pulse transmission means, as indicated by the arrow shown in the drawing. Here the movement pulse of the pressing element 7 is transmitted via the metal sheet 4 onto the molten masses of liquid soldering material. This leads to intensive mixing of the molten masses and almost total wetting of the metal sheets 4, 5 in the soldering region 6, and this results in a mechanically particularly resilient soldered connection following solidification of the homogeneous molten mass.

1. A method of soldering metallic join partners (4, 5) which are coated with soldering material, wherein the layers of soldering material of the join partners (4, 5) are pressed together and melted in a soldering region (6), molten masses of liquid soldering material forming which, after being mixed, in the solidified state connect the join partners (4, 5) in the soldering region (6), characterised in that a mechanical pulse is transmitted to the molten masses of liquid soldering material before solidification.

2. The method according to claim 1, characterised in that the join partners (4, 5) are moved impulsively in the soldering region (6) in order to transmit the pulse to the molten masses of soldering material.

3. The method according to claim 2, characterised in that the join partners (4, 5) are moved in relation to one another in the soldering region (6).

4. The method according to claim 1, characterised in that the join partners (4, 5) are compressed impulsively in the soldering region (6) in order to transmit the pulse to the molten masses of soldering material.

5. The method according to claim 4, characterised in that the join partners (4, 5) are moved in relation to one another for a few ms.

6. The method according to claim 1, characterised in that the layers of soldering material (3) are melted with a laser beam (12).

7. The method according to claim 1, characterised in that a mechanical pulse is transmitted to the molten masses of liquid soldering material using a pressing element (7).

8. The method according to claim 1, characterised in that a number of short pulses, in particular with a small amplitude, are transmitted to the molten masses of liquid soldering material.

9. An apparatus (1) for the soldering of metallic join partners (4, 5) coated with soldering material (3) which has a pressing device (2) in order to press the join partners (4, 5) against one another with their layers of soldering material in a soldering region (6) and a heating device (11) in order to melt the layers of soldering material (3) in the soldering region (6), characterised in that pulse transmission means are provided in order to transmit a mechanical pulse into the soldering region (6).

10. The apparatus (1) according to claim 9, characterised in that the pulse transmission means are designed to move the join partners (4, 5) impulsively in the soldering region (6).

11. The apparatus (1) according to claim 10, characterised in that the pulse transmission means are designed to move the join partners (4, 5) in relation to one another in the soldering region (6).

12. The apparatus (1) according to claim 9, characterised in that the pulse transmission means are designed to compress the join partners (4, 5) impulsively in the soldering region (6).

13. The apparatus (1) according to claim 9, characterised in that the heating device (11) is in the form of a laser.

14. The apparatus (1) according to claim 13, characterised in that the pressing device (2) has a pressing element (7) with a passage opening (10) formed in the latter for a laser beam (12).

15. The apparatus (1) according to claim 14, characterised in that the pressing element (7) is formed at least in parts as a heat insulator.

16. The apparatus (1) according to claim 14, characterised in that the pressing element (7) is mounted moveably.

17. The apparatus (1) according to claim 16, characterised in that the pressing element (7) is connected to the pulse transmission means so that a mechanical pulse can be transmitted via the pressing element (7) into the soldering region (6).

18. The apparatus (1) according to claim 9, characterised in that the pulse transmission means are designed to transmit a number of short impulses, in particular with a small amplitude, into the soldering region (6).
